(19) United States
(12) Patent Application Publication
(10) Pub. No.: US 2010/0185004 A1
(43) Pub. Date: Jul. 22, 2010

(54) SYSTEM, REACTOR AND PROCESS FOR THE CONTINUOUS INDUSTRIAL PRODUCTION OF POLYETHERALKYLALKOXYSILANES

(75) Inventors: Juergen Erwin Lang, Karlsruhe (DE); Georg Markowz, Alzenau (DE); Dietmar Wewers, Bottrop (DE); Harald Metz, Frankfurt (DE); Norbert Schladerbeck, Kelkheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Degussa GmbH, Essen (DE)

(21) Appl. No.: 12/376,576

(22) PCT Filed: Jul. 9, 2007
(86) PCT No.: PCT/EP07/56919

§ 371 Date: Feb. 6, 2009

(30) Foreign Application Priority Data
Aug. 10, 2006 (DE) 10 2006 037 401.0
May 22, 2007 (DE) 10 2007 023 763.6

(51) Int. Cl. C07F 7/08; B01J 19/00; B01J 8/06

(52) U.S. Cl. 556/445; 422/189; 422/190; 422/192

(57) ABSTRACT

The present invention relates to a system, a reactor and a process for the continuous industrial conduct of a reaction where a b-unsaturated aliphatic polyether compound A is reacted with an HSi compound B in the presence of a catalyst C and optionally of other auxiliaries, and the system is at least based on the system (3) for combining the starting materials for components A (1) and B (2), on at least one multielement reactor (5) which in turn comprises at least two reactor units in the form of exchangeable pre-reactors (5.1) and comprises at least one further reactor unit (5.3) downstream of the pre-reactors, and on a product-work-up system (8).

The present invention relates to a new reactor and a system for the continuous industrial production of polyetheralkylalkoxysilanes by reaction of an α,β-unsaturated aliphatic polyether compound with an HSi compound, and also to a corresponding process.

Organosilanes, such as vinylchlorosilanes and vinylalkoxysilanes (EP 0 456 901 A1, EP 0 806 427 A2), chloroalkylchlorosilanes (DE-B 28 15 316, EP 0 519 181 A1, DE 195 34 853 A1, EP 0 823 434 A1, EP 1 020 473 A2), alkylalkoxysilanes (EP 0 714 901 A1, DE 101 52 284 A1), fluoroalkylalkoxysilanes (EP 0 838 467 A1, DE 103 01 997 A1), aminoalkylalkoxysilanes (DE-A 27 53 124, EP 0 709 391 A2, EP 0 849 271 A2, EP 1 209 162 A2, EP 1 295 889 A2), glycidyloxyalkylalkoxysilanes (EP 1 070 721 A2, EP 0 934 947 A2), methacryloyloxyalkylalkoxysilanes (EP 0 707 009 Al, EP 0 708 081 A2), polyetheralkylalkoxysilanes (EP 0 387 689 A2), and many more, are of high technical and industrial interest. Processes and systems for their production are well established. These products are comparatively low-tonnage products and are produced predominantly in batch processes. Generally this is done using systems which can be used many times, in order to maximize the degree of capacity utilization of the batch systems. When there is a changeover of product, however, extensive cleaning and rinsing operations are necessary on such batch systems. Furthermore, in many cases, long residence times of the reaction mixture in a high-volume, expensive, and labour-intensive batch system are necessary in order to obtain a sufficient yield. Furthermore, said reactions are often considerably exothermic, with heats of reaction in the range from 100 to 180 kJ/mol. In the course of the reaction, therefore, it is also possible for unwanted secondary reactions to have a considerable influence on selectivity and yield. Where said reactions are hydrosilylations, the possible elimination of hydrogen poses considerable challenges for the safety engineering. Frequently, furthermore, in a semibatch procedure, a reactant is introduced together with the catalyst, and the other reactant is metered in. Furthermore, even small fluctuations in the process regime of batch or semibatch systems can lead to a considerable scatter of the yields and product qualities over different batches. If the aim is to scale up results from the laboratory/pilot-plant scale to the batch scale, it is also not uncommon for difficulties to occur.

Microstructured reactions per se, for the purpose for example of continuous production of polyether alcohols (DE 10 2004 013 551 A1) or the synthesis of products including ammonia, methanol, and MTBE (WO 03/078052), are known. Also known are microreactors for catalytic reactions (WO 01/54807). To date, however, the microreactor technology has been omitted for the industrial production of organosilanes, or at least not realized. The tendency of alkoxysilanes and chlorosilanes to undergo hydrolysis—in the case even of small amounts of moisture—and corresponding instances of wall deposits in an organosilane production system, are likely seen as a persistent problem.

The object was therefore to provide a further possibility for the industrial production of polyetheralkylalkoxysilanes. A particular concern was to provide a further possibility for the continuous production of such organosilanes, the aim being to minimize the disadvantages identified above.

The object proposed is achieved in accordance with the invention in accordance with the details in the claims.

In the case of the present invention it has surprisingly been found that the hydrosilylation of an HSi-containing component B, more particularly a hydrogenalkoxysilane, with an α,β-unsaturated aliphatic polyether compound (component A) can be carried out advantageously in the presence of a catalyst C, in a simple and economic way on an industrial scale and continuously, in a system based on a multielement reactor (5), the multielement reactor (5) more particularly comprising at least two reactor units in the form of replaceable preliminary reactors (5.1) and at least one further reactor unit (5.3) downstream of the preliminary reactors.

Advantageously, therefore, through the use of a multielement reactor (5) in the present embodiment, it is possible to contribute to the continuous operation of the operation according to the invention, since the present multielement reactor (5) permits the deliberate replacement, in rotation, of preliminary reactors in which, after a period of operation, significant amounts of hydrolyzate are deposited, by fresh preliminary reactors, even under operating conditions.

In this context it is possible in a particularly advantageous way to use preliminary reactors which are furnished with packing elements, thereby making it possible even more deliberately and effectively to obtain deposition of hydrolyzate or hydrolyzate particles and hence a reduction in the tendency toward clogging and downtimes of the system as a result of floor and wall deposits in the reactor.

In contradistinction to what is the case with a batch approach, it is possible in the case of the present invention to carry out continuous premixing of the reactants immediately ahead of the multielement reactor; the premixing may also take place cold, with subsequent heating in the multielement reactor for purposive and continuous reaction therein. It is also possible to add a catalyst to the reactant mixture. Subsequently the product can be worked up continuously, as for example in an evaporation or rectification procedure and/or in a short-path or thin-film evaporator—to name just a few possibilities. In the multielement reactor, the heat of reaction that is liberated during the reaction can be taken off advantageously via the surface area of the internal reactor walls, which is large in relation to the reactor volume, and, where provided, to a heat transfer medium. Furthermore, in the case of the present application of multielement reactors, it is possible to achieve a significant increase in the space/time yield of rapid, exothermic reactions. This is made possible by more rapid mixing of the reactants, a higher average concentration level of the reactants than in the case of the batch process, i.e., no limitation as a result of reactant depletion, and/or an increase in the temperature, which in general is able to produce an additional acceleration of the reaction. Furthermore, in a comparatively simple and economic way, the present invention permits operational safety to be preserved. Thus it has been possible in the case of the present invention to achieve a drastic intensification of operation, more particularly a shortening of the operating time under reaction conditions by more than 99%, based on the space/time yield, in comparison to the standard batch process. At the same time, increased yields of up to 20% have been achieved as a result of higher conversions and selectivities. The present reactions were carried out with preference in a stainless steel multielement reactor. In this way it is possible, with advantage, to do without the use of specialty materials for the implementation of said reactions. In addition it is possible, as a result of the continuous operation in reactions that are to be carried out under pressure, to observe a longer service life of the metal reactors, since the material suffers fatigue much more slowly than in a batch procedure. Moreover, distinct improvements have been achieved in reproducibility in relation to comparable investigations in the case of batch processes. In addition, in the case of the present process, there is a significantly reduced scale-up risk when the results from the laboratory scale or pilot-plant scale are transposed. More particularly, in the case of the present continuous process utilizing a system according to the invention, where a multielement reactor advantageously comprises at least one replaceable preliminary reactor, packed preferably with packing elements, it is possible to permit a surprisingly long running time of the system, even without downtime caused by floor and wall deposits. Furthermore, in a surprising way, it has been found that in the case of the present process it is particularly advantageous to rinse the multielement reactor, prior to the start of the reaction proper, with the reaction mixture, more particularly when said mixture comprises a homogeneous catalyst; in other words, to carry out preconditioning of the multielement reactor. As a result of this measure it is possible to produce an unexpectedly rapid coming-about of consistent operating conditions at a high level.

The present invention accordingly provides a system for the continuous industrial implementation of a reaction, an α,β-unsaturated aliphatic polyether compound A being reacted with an HSi compound B in the presence of a catalyst C and optionally of further auxiliaries, and the system being based at least on the reactant combiner (3) for components A (1) and B (2), on at least one multielement reactor (5), which in turn comprises at least two reactor units in the form of at least one replaceable preliminary reactor (5.1) and at least one further reactor unit (5.3), downstream of the preliminary reactor system, and on a product workup unit (8).

The present invention further provides a multielement reactor (5) for the reaction of hydrolyzable silanes, more particularly of those which contain HSi units, which in turn comprises at least two reactor units in the form of at least one replaceable preliminary reactor (5.1) and at least one further reactor unit (5.3) downstream of the preliminary reactor system.

Preference is given here to preliminary reactors (5.1) which are equipped with packing elements. Suitable packing elements for this purpose include for example—but not exclusively—structured packing elements, i.e., regular or irregular particles of identical or different size, preferably with an average particle size, the average particle diameter of the cross-sectional area being ⅓, more preferably 1/10 to 1/100, of the free cross section of the respective reactor unit (5.1), and also the average particle cross-sectional area being preferably 100 to 10⁻⁶ mm², such as chips, fibers/wool, beads, shards, strands with a circular or approximately circular or polygonal cross section, spirals, cylinders, tubes, cups, saddles, honeycombs, plates, meshes, wovens, open-pored sponges, irregular shaped and hollow articles, (structured) packings or bound assemblies of aforementioned structural elements, etc., spherical elements of metal, metal oxide, ceramic, glass or plastic (such as steel, stainless steel, titanium, copper, aluminum, titanium oxides, aluminum oxides, corundum, silicon oxides, quartz, silicates, clays, zeolites, alkali glass, boron glass, quartz glass, porous ceramic, vitreous ceramic, specialty ceramic, SiC, Si₃N₄, BN, SiBNC, . . . and many more.

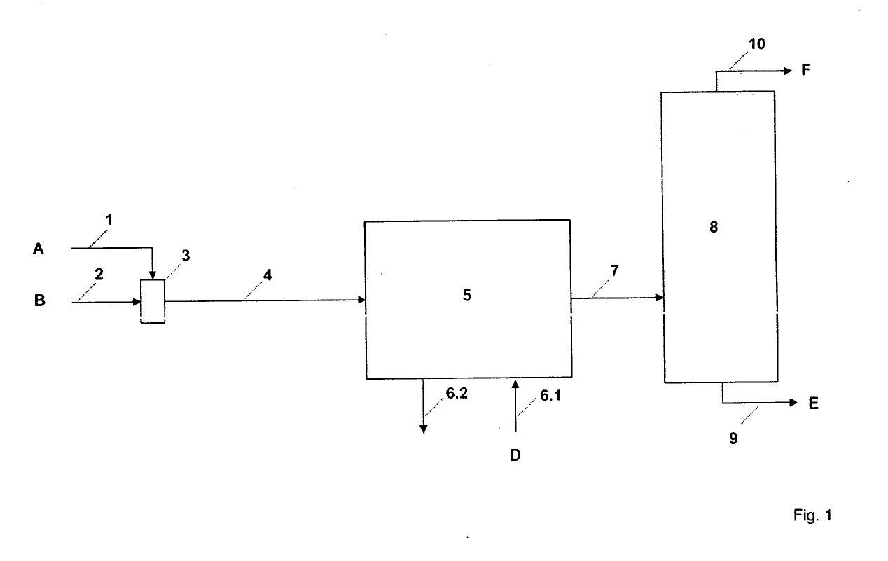

FIGS. 1 to 6 show flow diagrams of systems or system parts as preferred embodiments of the present invention.

Thus, FIG. 1 shows a preferred continuous system in which the reactant components

A and B are brought together in the unit (3), supplied to the unit (5), which may contain an immobilized catalyst, and reacted therein, and the reaction product is worked up in the unit (8).

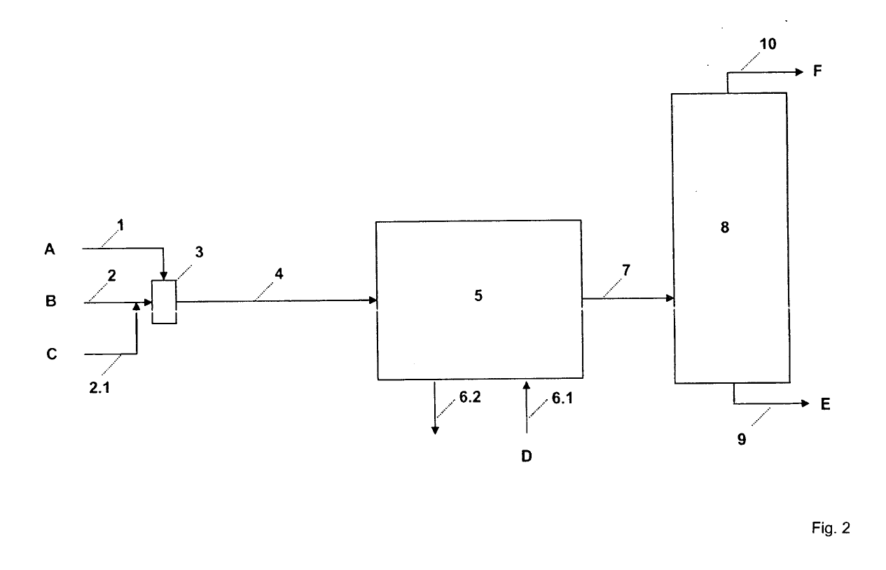

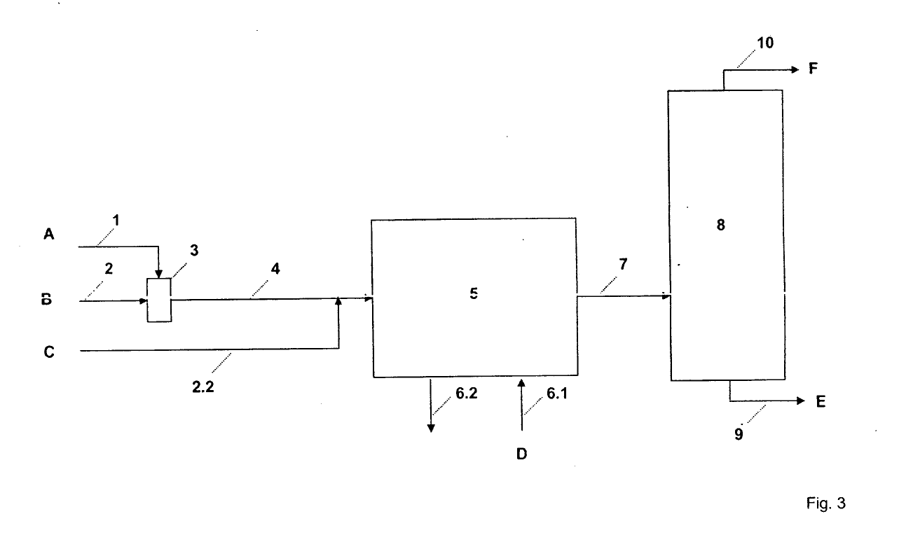

FIG. 2 shows a further preferred embodiment of a present continuous system, a catalyst C being supplied to component B. The catalyst, more particularly a homogeneous catalyst, may alternatively be supplied to unit (3) or—as apparent from FIG. 3—the catalyst C may be metered into a mixture of components A and B shortly prior to entry into the multielement reactor unit (5).

Furthermore, further auxiliaries may optionally be added to each of the aforementioned streams.

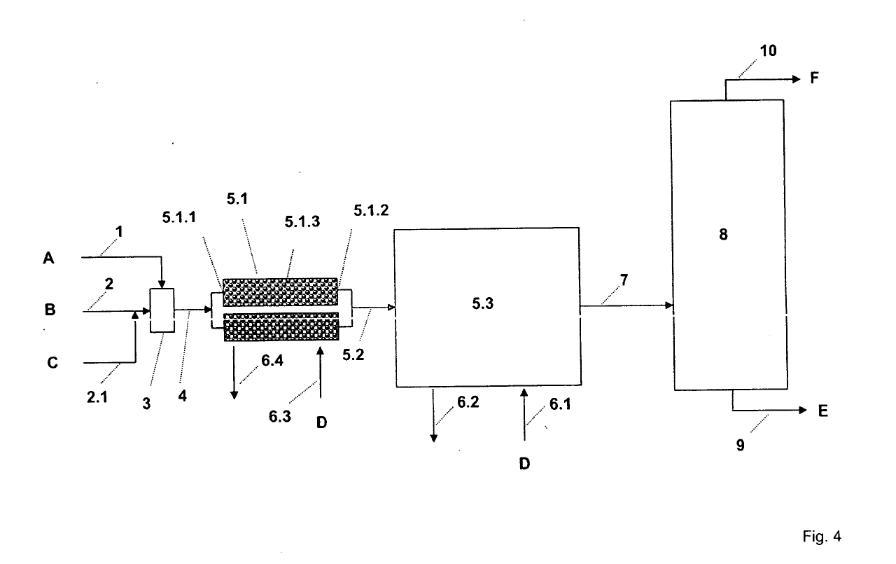

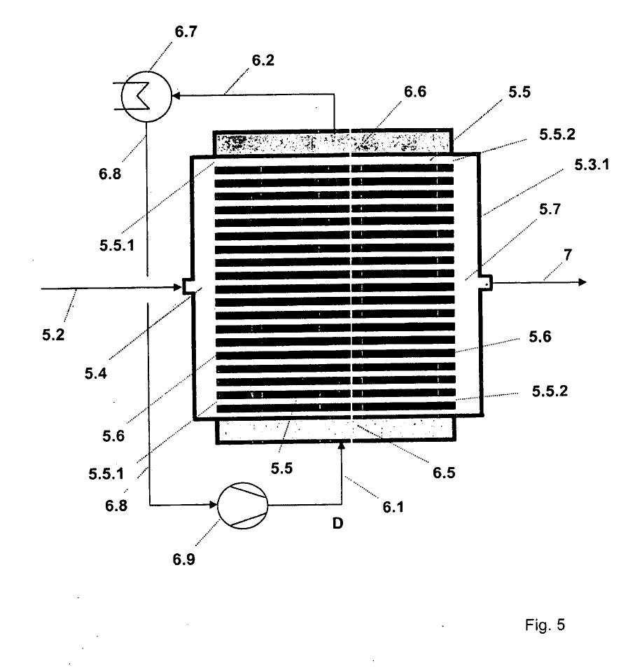

By a reactor unit in this context is meant an element of the multielement reactor (5), each element representing a region or reaction chamber for the stated reaction; cf., for example, (5.1) (reactor unit in the form of a preliminary reactor) in FIG. 4 and also (5.5) [reactor unit of an integrated block reactor (5.3.1)] in FIG. 5, and also (5.10) [reactor unit of a micro-tube bundle heat exchanger reactor (5.9)]. Therefore, reactor units of a multielement reactor (5) for the purposes of the present invention are more particularly stainless-steel or quartz-glass capillaries, stainless-steel tubes or well-dimensioned stainless-steel reactors, examples being preliminary reactors (5.1), tubes (5.10) in micro-tube bundle heat exchanger reactors [e.g., (5.9)] and also regions (5.5) delimited by walls, in the form of integrated block reactors [e.g., (5.3.1)]. The internal walls of the reactor elements may be coated, with, for example, a ceramic layer, a layer of metal oxides, such as Al₂O₃, TiO₂, SiO₂, ZrO₂, zeolites, silicates, to name but a few, although organic polymers, more particularly fluoropolymers, such as Teflon, are also possible.

Accordingly a system of the invention comprises one or more multielement reactors (5) which in turn are based on at least 2 up to 1 000 000 reactor units, including all of the natural numbers situated in between, preferably from 3 to 10 000, more particularly from 4 to 1000 reactor units.

The reactor chamber or reaction chamber of at least one reactor unit preferably has a semicircular, semioval, circular, oval, triangular, square, rectangular or trapezoidal cross section normal to the direction of flow. Such a cross section preferably possesses a cross-sectional area of 75 μm² to 75 cm². Particular preference is given to cross-sectional areas of 0.7 to 120 mm² and all numerical values situated numerically in between. In the case of circular cross-sectional areas, a diameter of ≧30 μm to <15 mm, more particularly 150 μm to 10 mm, is preferred. Polygonal cross-sectional areas have edge lengths preferably of ≧30 μm to <15 mm, preferably 0.1 to 12 mm. In one multielement reactor (5) of a system of the invention there may be reactor units having different-shaped cross-sectional areas.

Furthermore, the structure length in a reactor unit, i.e., from entry point of the reaction stream or product stream into the reactor unit, cf. e.g. (5.1 and 5.1.1) or (5.5 and 5.5.1), to the exit point, cf. (5.1.2) or (5.5.2), is preferably 5 cm to 500 m, including all numerical values situated numerically in between, more preferably ≧15 cm to 100 m, very preferably 20 cm to 50 m, more particularly 25 cm to 30 m.

In a system of the invention preference is given to reactor units whose respective reaction volume (also referred to as reactor volume, i.e., the product of cross-sectional area and structure length) is 0.01 ml to 100 l, including all numerical values situated numerically in between. With particular preference the reactor volume of one reactor unit of a system of the invention is 0.05 ml to 10 l, very preferably 1 ml to 5 l, very preferably 3 ml to 2 l, more particularly 5 ml to 500 ml.

In addition it is possible to base systems of the invention on one or more multielement reactors (5), which are preferably connected in parallel. Alternatively said multielement reactors (5) can be connected in series, and so the product coming from the upstream multielement reactor can be supplied to the inlet of the downstream multielement reactor.

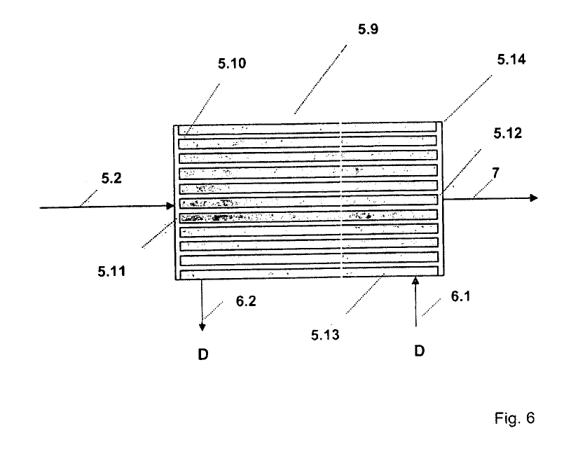

Present multielement reactors (5) can be fed advantageously with a reactant component stream (4) or (5.2), suitably divided into the respective substreams, cf. e.g. (5.4) in FIG. 5 and also (5.11) in FIG. 6. Following the reaction, the product streams can be brought together, cf. e.g. (5.7) in FIG. 5, (5.12) in FIG. 6 and also (7), and then advantageously worked up in a workup unit (8). A workup unit (8) of this kind may to start with have a condensation stage or evaporation stage, which is followed by one or more distillation stages.

Furthermore, a multielement reactor (5) of a system of the invention may be based on at least one, preferably at least two, stainless-steel capillaries connected in parallel, or on at least two quartz-glass capillaries connected in parallel, or on at least one tube-bundle heat exchanger reactor (5.9) or on at least one integrated block reactor (5.3.1).

In this context it is possible more particularly to use stainless-steel capillaries, reactors, and preliminary reactors, which are composed advantageously of a high-strength, high-temperature-resistant, and nonrusting stainless steel; by way of example, but not exclusively, preliminary reactors, capillaries, block reactors, tube bundle heat exchanger reactors, etc., are composed of steel of grade 1.4571 or 1.4462, cf. more particularly also steel according to DIN 17007. Furthermore, the surface of a stainless-steel capillary or of a multielement reactor that faces the reaction chamber may be furnished with a polymer layer, such as a fluorine-containing layer, Teflon inter alia, or with a ceramic layer, preferably a nonporous or porous SiO₂, TiO₂ or Al₂O₃ layer, intended more particularly for the accommodation of a catalyst.

More particularly it is possible with advantage to use an integrated block reactor, of the kind apparent, for example, as a temperature-controllable block reactor, constructed from metal plates with defined structuring (also called planes below), from http://www.heatric.com/pche-construction.html.

The production of said structured metal plates or planes from which a block reactor can then be produced may take place, for example, by etching, turning, cutting, milling, embossing, rolling, spark erosion, laser machining, plasma technique or another technique of the machining methods known per se. In this way, with an extremely high level of precision, well-defined and targetedly arranged structures, such as grooves or joints, are incorporated on one side of a metal plate, more particularly a metal plate made of stainless steel. The respective grooves or joints begin at one end face of the metal plate, are continuous, and end generally at the opposite end face of the metal plate.

Thus FIG. 5 shows one plane of an integrated block reactor (5.3.1) having a plurality of reactor units or elements (5.5). A plane of this kind is composed generally of a metal base plate with metal walls (5.6) thereon that delimit the reaction chambers (5.5), together with a metal top plate, and also with a temperature control unit (6.5, 6.6), preferably with a further plane or structured metal plate. The unit (5.3.1) further comprises a region (5.4) for the input and distribution of the reactant mixture (5.2) into the reactor elements (5.5), and a region (5.7) for the bringing-together of the product streams from the reaction regions (5.5) and discharge of the product stream (7). Furthermore, as part of an integrated block reactor (5.3.1), there may also be two or more such above-described planes connected one above another. The connection may be carried out, for example, by (diffusion) welding or soldering; on such working techniques and others which can be employed here cf. also www.imm-mainz.de/seiten/de/u_{—}050527115034_{—}2679.php?PHPSESSID=75a6285eb0433122b9c ecaca3092dadb. Furthermore, integrated block reactors (5.3.1) of this kind are advantageously surrounded by a temperature control unit (6.5, 6.6) which allows the heating or cooling of the block reactor (5.3.1), i.e., a targeted temperature control regime. For this purpose a medium (D), e.g., Marlotherm or Mediatherm, may be brought to the desired temperature by means of a heat exchanger (6.7) and supplied via line (6.8) to a pump (6.9) and line (6.1) to the temperature control unit (6.5), and discharged via (6.6) and (6.2), and supplied to the heat exchanger unit (6.7). Heat of reaction released in an integrated block reactor (5.3.1) can be controlled optimally in a very short path, thereby making it possible to avoid temperature spikes with an adverse effect on a controlled reaction regime. Alternatively the integrated block reactor (5.3.1) and the associated temperature control unit (6.5, 6.6) may also be configured such that there is a temperature control plane arranged between each two reactor element planes, said temperature control plane permitting an even more directed control of the thermal conditioning medium between the regions (6.1, 6.5) and (6.6, 6.2).

In systems of the invention preference is given more particularly to a multielement reactor (5) which comprises at least one preliminary reactor (5.1) and at least one further reactor unit (5.3), a stainless-steel capillary for example, or at least one preliminary reactor (5.1) and at least one integrated block reactor (5.3.1) or at least one preliminary reactor (5.1) and at least one micro-tube bundle heat exchanger reactor (5.9); cf. FIG. 4. Furthermore, the preliminary reactor (5.1) is designed so as to be suitably temperature-controllable, i.e., coolable and/or heatable (D, 6.3, 6.4).

In general, even traces of water lead to the hydrolysis of the alkoxysilane or chlorosilane reactants and hence to instances of floor or wall deposits. The particular advantage of such an embodiment of a preliminary reactor (5.1) in the context of the multielement reactor (5), more particularly for the reaction of silanes, is that, in addition to the continuous reaction carried out through deliberate deposition and removal of hydrolyzates or particles, it is possible advantageously to minimize unplanned idle times and downtime. Hence the preliminary reactors (5.1) equipped in accordance with the invention may additionally be fitted, upstream and/or downstream, with filters for particle deposition.

Generally speaking, a system of the invention for the continuous industrial implementation of reactions is based on a reactant combiner (3) for components A and B, on at least one said multielement reactor (5), and on a product workup unit (8), cf. FIGS. 1, 2, and 3, the multielement reactor (5) comprising at least two reactor units in the form of replaceable preliminary reactors (5.1), which are preferably equipped with packing elements, and at least one further reactor unit (5.3) downstream of the preliminary reactor system.

The reactant components A and B may each be brought deliberately together, continuously, in the region (3) from a reservoir unit by means of pumps and, optionally, by means of a differential weighing system. Generally speaking, components A and B are metered, and mixed in the region (3), at ambient temperature, preferably at 10 to 40° C. Alternatively at least one of the components, both components or ingredients, or the corresponding mixture may also be preheated. Hence said reservoir unit may be brought to temperature, and the reservoir vessels may also be of temperature-controllable design. Furthermore, the reactant components may be brought together under pressure. The reactant mixture can be supplied continuously to the multielement reactor (5) via line (4).

The multielement reactor (5) is preferably brought to and held at the desired operating temperature by means of a temperature control medium D (6.1, 6.2), so that unwanted temperature spikes and temperature fluctuations, as known from batch plants, can be advantageously prevented or sufficiently minimized in the case of the present system of the invention.

The product stream or crude-product stream (7) is supplied continuously to the product workup unit (8), a rectifying unit for example, in which case a low-boiling product F, as for example silane which is used in excess and is optimally recyclable, can be taken off continuously, for example, via the top (10), while via the bottom (9) a higher-boiling product E can be taken off continuously. It is also possible, however, to take off side streams as a product from the unit (8).

If it is necessary to have to carry out the reaction of components A and B in the presence of a catalyst C, then it is possible, advantageously, to insert a homogeneous catalyst into the reactant stream by metering. An alternative option is to use a suspension catalyst, which can likewise be metered into the reactant stream. In this case the maximum particle diameter of the suspension catalyst ought advantageously to amount to less than ⅓ of the extent of the smallest free cross-sectional area of a reactor unit of the multielement reactor (5).

Thus FIG. 2 shows that a said catalyst C is advantageously metered into component B, before the latter is brought together with component A in the region (3).

A homogeneous catalyst C or a suspension catalyst C may alternatively be metered into a mixture of A and B, which is conducted in line (4), preferably shortly prior to entry into the multielement reactor, via a line (2.2); cf. FIG. 3.

In the same way as in the case of a homogeneous catalyst, the reactant components A and B may also be admixed with further, predominantly liquid auxiliaries, such as, for example—but not exclusively—activators, initiators, stabilizers, inhibitors, solvents, diluents, etc.

Another possibility, however, is to choose a multielement reactor (5) which is equipped with an immobilized catalyst C; cf. FIG. 1. The catalyst C may be present for example—but not exclusively—at the surface of the reaction chamber of the respective reactor elements.

Generally speaking, a system of the invention for the continuous industrial implementation of the reaction of a said compound A with a compound B, optionally in the presence of a catalyst and also further auxiliaries, is based on at least one reactant combiner (3), at least one multielement reactor (5), which in turn comprises at least two reactor units of the invention, and on a product workup unit (8). Suitably the reactants or ingredients are provided in a reservoir unit for the implementation of the reaction, and are supplied or metered as required. Furthermore, a system of the invention is equipped with the measuring, metering, blocking, transporting, conveying, monitoring, and control units, and also offgas and waste processing apparatus, that are customary per se in the art. In addition, a system of the invention of this kind may advantageously be accommodated in a transportable and stackable container, and made flexible. Thus a system of the invention may be brought rapidly and flexibly, for example, to the particular reactant or energy sources required. With a system of the invention, however, it is also possible to provide product continuously with all of the advantages, more specifically at the site at which the product is further-processed or further-used, as for example directly at customers' premises.

A further advantage, deserving particular emphasis, of a system of the invention for the continuous industrial implementation of a reaction of α,β-unsaturated compounds A with an HSi compound B is that a facility is now also available for preparing small specialty products, with volumes of between 5 kg and 100 000 t p. a., preferably 10 kg to 10 000 t p. a., continuously and flexibly in a simple and economic way. Unnecessary idle times, temperature spikes and temperature fluctuations effecting the yield and selectivity, and also excessively long residence times and hence unwanted side reactions can be advantageously avoided. In particular it is also possible to utilize such a system optimally for the preparation of present silanes from economic, environmental, and customer convenience standpoints.

The present invention accordingly further provides a process for the continuous industrial production of a polyetheralkylalkoxysilane of the general formula (I)

Y—Si(R′)ₘ(OR)₃₋ₘ (I),

in which Y is a polyetheralkyl group of the form H₃C[O—(CH₂)₂]ₙO—(CH₂)₃— with n=1 to 20 or H[O—(CH₂)₂]ₙO—(CH₂)₃— with n=1 to 20, R′ and R independently are a C₁ to C₄ alkyl group, preferably methyl, ethyl, n-propyl, and m is 0 or 1,

the reaction of the reactant components A and B in the presence of a catalyst C and also optionally of further components being carried out in a multielement reactor (5) which in turn is based on at least two reactor units in the form of at least one replaceable preliminary reactor (5.1) and at least one further reactor unit (5.3) downstream of the preliminary reactor system.

This reaction is preferably carried out in at least one multielement reactor (5) whose reactor units are composed of stainless steel or quartz glass or whose reaction chambers are delimited by stainless steel or quartz glass, it being possible for the surfaces of the reactor units to have been coated or lined, with Teflon, for example.

In processes according to the invention it is preferred, furthermore, to use reactor units whose respective cross section is semicircular, semioval, circular, oval, triangular, square, rectangular or trapezoidal.

Use is made advantageously in this context of reactor units whose respective cross-sectional area is 75 μm² to 75 cm².

Furthermore, the reactor units used preferably are those which have a structure length of 5 cm to 200 m, more preferably 10 cm to 120 m, very preferably 15 cm to 80 m, more particularly 18 cm to 30 m, including all possible numerical values which are included by the ranges stated above.

Thus use is suitably made, in the process according to the invention, of reactor units whose respective reaction volume is 0.01 ml to 100 l, including all numerical values situated numerically in between, preferably 0.1 ml to 50 l, more preferably 1 ml to 20 l, very preferably 2 ml to 10 l, more particularly 5 ml to 5 l.

In the case of the process of the invention it is likewise possible advantageously to carry out the said reaction in a system with a multielement reactor (5) which is based (i) on at least two preliminary reactors (5.1) connected in parallel and on at least one stainless-steel capillary downstream of the preliminary reactors, or (ii) on at least two preliminary reactors (5.1) connected in parallel and on at least one quartz-glass capillary downstream of the preliminary reactors, or (iii) on at least two preliminary reactors (5.1) connected in parallel and on at least one integrated block reactor (5.3.1), or (iv) on at least two preliminary reactors (5.1) connected in parallel and on at least one tube-bundle heat exchanger reactor (5.9).

Particular preference is given in this context to a multielement reactor (5) which comprises at least two replaceable preliminary reactors (5.1) according to the invention, said preliminary reactors being furnished with packing elements, of the kind set out more particularly above, for the purpose of depositing hydrolysis products of hydrolyzable silanes that are used. With particular preference the method of the invention is carried out in reactor units made of stainless steel.

A further preference is for the surface of the reactor units of the multielement reactor that is in contact with the reactant/product mixture to be lined with a catalyst in the process according to the invention.

Where, as part of the process of the invention, the reaction of components A and B is carried out in the presence of a homogeneous catalyst C, it has surprisingly been found that it is particularly advantageous to carry out preconditioning of the multielement reactor by means of one or more flushes with a mixture of homogeneous catalyst C and component B, or of homogeneous catalyst C and components A and B, or short-term operation of the system, for 10 to 120 minutes, for example, and optionally with a relatively high catalyst concentration.

The materials used for the preconditioning of the multielement reactor may be collected and later on metered in again, at least proportionally, to the reactant stream or supplied directly to the product workup unit and worked up.

By virtue of the preconditioning of the multielement reactor as described above, more particularly when said reactor is composed of stainless steel, it is possible, in a surprising and advantageous way, to obtain a constant operating state with maximum yield more quickly.

In the context of the process of the invention, the stated reaction can be carried out in the gas and/or liquid phase. The reaction mixture and/or product mixture may be a single-phase, two-phase or three-phase mixture. With the method of the invention the reaction is preferably carried out in single-phase form, more particularly in the liquid phase.

Hence the process of the invention is operated advantageously using a multielement reactor at a temperature of 10 to 250° C. under a pressure of 0.1 to 500 bar abs. Preferably the reaction of components A and B, more particularly a hydrosilylation, is carried out in the multielement reactor at a temperature of 50 to 200° C., preferably at 60 to 180° C., and at a pressure of 0.5 to 300 bar abs, preferably at 1 to 200 bar abs, more preferably at 2 to 50 bar abs.

In general the pressure difference in a system of the invention, i.e., between reactant combiner (3) and product workup unit (8), is 1 to 10 bar abs. It is possible with advantage to equip a system of the invention with a pressure maintenance valve, especially when using trimethoxysilane (TMOS). The pressure maintenance valve is set preferably at from 1 to 100 bar abs, more preferably up to 70 bar abs, with particular preference up to 40 bar abs, more particularly to a value between 10 to 35 bar abs.

The reaction can be carried out in accordance with the invention at a linear velocity (LV) of 1 to 1·10⁴ h⁻¹ (stp). The flow rate of the stream of material in the reactor units is preferably in the range from 0.0001 to 1 m/s (stp), more preferably 0.0005 to 0.7 m/s, more particularly 0.05 to 0.3 m/s, and all possible numbers within the aforementioned ranges. If the ratio of reactor surface (A) prevailing in the case of inventive reaction is related to the reactor volume (V), then preference is given to an A/V ratio of 20 to 5000 m²/m³—including all numerically possible individual values which lie within the stated range—for the advantageous implementation of the process of the invention. The A/V ratio is a measure of the heat transfer and also of possible heterogeneous (wall) effects.

Thus the reaction in processes of the invention is carried out advantageously with an average residence time (θ) of 10 seconds to 60 minutes, preferably 1 to 30 minutes, more preferably 2 to 20 minutes, more particularly 3 to 10 minutes. Here again, specific reference is to all possible numerical values disclosed by the stated range.

As component A it is possible in the process of the invention to make use for example—but not exclusively—of the following α,β-unsaturated polyether compounds or corresponding mixtures thereof:

H₃C[O—(CH₂)₂]ₙO—CH₂CH═CH₂ with n=1 to 20, more particularly the numbers 2, 3, 4, 5, 6, 7, 8, 9, 10, 11, 12, 13, 14, 15, 16, 17, 18, and 19, H[O—(CH₂)₂]ₙO—CH₂CH═CH₂ with n=1 to 20, more particularly 2, 3, 4, 5, 6, 7, 8, 9, 10, 11, 12, 13, 14, 15, 16, 17, 18, and 19.

The process of the invention is used preferably to prepare Dynasylan® 4140, 3-(methylpolyethylene glycol)propyltrialkoxysilane, corresponding to the general formula (I) with m=0 and with n=2 to 20, more preferably 4 to 18, very preferably 6 to 16, more particularly with 8 to 12, i.e., on average around 10.

Suitable components B in the process of the invention are silanes of the general formula (II)

HSi(R′)ₘ(OR)₃₋ₘ (II),

in which R′ and R independently are a C₁ to C₄ alkyl group and m is 0 or 1, preferably R′ being methyl and group R preferably being methyl or ethyl.

Hence in accordance with the invention it is preferred to use trimethoxysilane (TMOS), triethoxysilane (TEOS), methyldimethoxysilane or methyldiethoxysilane.

In the process of the invention the components A and B are used preferably in a molar ratio of A to B of 1:5 to 100:1, more preferably 1:4 to 5:1, very preferably 1:2 to 2:1, for example—but not exclusively—1:0.7 to 0.9, more particularly from 1.0:1.5 to 1.5:1.0, including all possible numbers within the aforementioned ranges.

The process of the invention is carried out preferably in the presence of a homogeneous catalyst C. However, the process of the invention can also be operated without the addition of a catalyst, in which case, generally, a distinct drop in yield is likely.

The process of the invention is utilized more particularly for the implementation of a hydrosilylation reaction for the preparation of organosilanes of formula (I), with, more particularly, homogeneous catalysts from the series of Pt complex catalysts, such as those of the Karstedt type, for example, such as Pt(0)-divinyltetramethyldisiloxane in xylene, PtCl₄, H₂[PtCl₆] or H₂[PtCl₆]·6H₂O, preferably a “Speyer catalyst”, cis-(Ph₃P)₂PtCl₂, complex catalysts of Pd, Rh, Ru, Cu, Ag, Au, Ir or those of other transition metals and/or noble metals. The complex catalysts known per se may be dissolved in an organic solvent, preferably a polar solvent, for example—but not exclusively—ethers, such as THF, ketones, such as acetone, alcohols, such as isopropanol, aliphatic or aromatic hydrocarbons, such as toluene, xylene.

Additionally the homogeneous catalyst or the solution of the homogeneous catalyst may be admixed with an activator, in the form for example of an organic or inorganic acid, such as HCl, H₂SO₄, H₃PO₄, monocarboxylic and/or dicarboxylic acids, HCOOH, H₃C—COOH, propionic acid, oxalic acid, succinic acid, citric acid, benzoic acid, phthalic acid—to name but a few.

Furthermore, the addition of an organic or inorganic acid to the reaction mixture may take on another advantageous function, for example as a stabilizer or inhibitor for impurities in the trace range.

Where a homogeneous catalyst or a suspension catalyst is used in the process of the invention, the olefin component A is used relative to the catalyst, based on the metal, preferably in a molar ratio of 2 000 000:1 to 1000:1, more preferably of 1 000 000:1 to 4000:1, more particularly of 500 000:1 to 10 000:1, and all possible numerical values within the ranges stated above.

It is also possible, however, to use an immobilized catalyst or heterogeneous catalyst from the series of the transition metals and/or noble metals, and/or a corresponding multielement catalyst, for carrying out the hydrosilylation reaction. Thus it is possible for example—but not exclusively—to use noble metal slurries or noble metal on activated carbon. An alternative is to provide a fixed bed for the accommodation of a heterogeneous catalyst in the region of the multielement reactor. Thus, for example—but not exclusively—it is also possible to incorporate heterogeneous catalysts, on a support, such as beads, strands, pellets, cylinders, stirrers, etc., of SiO₂, TiO₂, Al₂O₃, ZrO₂, among others, into the reaction region of the reactor units.

Examples of integrated block reactors with a fixed catalyst bed are given at http://www.heatric.com/iqs/sid.0833095090382426307150/mab_reactors.html.

As auxiliaries it is possible, furthermore, to use solvents and diluents, such as alcohols, aliphatic and aromatic hydrocarbons, ethers, esters, ketones, CHC, FCHC—to name but a few. Such auxiliaries may be removed from the product, for example, in the product workup unit.

In the case of the present process it is likewise possible to use inhibitors, examples being polymerization inhibitors or corresponding mixtures, as additional auxiliaries.

The process of the invention is generally carried out as follows:

In general the reactant components A, B, and, if appropriate, C, and also any further auxiliaries, are first metered in and mixed. The aim here is to meter a homogeneous catalyst with an accuracy of ≦±20%, preferably ≦±10%. In particular cases the homogeneous catalyst and also, optionally, further auxiliaries may also only be metered into the mixture of components A and B shortly before entry into the multielement reactor. Subsequently the reactant mixture can be supplied to the multielement reactor, and the components reacted, with the temperature being monitored. An alternative is first to flush or precondition the multielement reactor with a catalyst-containing reactant or reactant mixture, before running up the temperature in order to carry out the reaction. The preconditioning of the multielement reactor can alternatively be carried out at a slightly elevated temperature. The product streams brought together or obtained in the multielement reactor (crude product) can thereafter be worked up appropriately in a product workup unit of the system of the invention, by means for example—but not exclusively—of a vacuum distillation facility, in which case stripping agents may also be used. The method is preferably operated continuously.

Thus the process of the invention can be operated continuously using a system of the invention, in an advantageous way, with a product discharge of 5 kg to 100 000 t p. a. The present invention is illustrated by the following example, without the subject matter being restricted.

### EXAMPLES

### Example 1

### Preparation of 3-(methyl polyethylene glycol)propyltrimethoxysilane

The system used for the continuous preparation of 3-(methylpolyethylene glycol)propyl-trimethoxysilane (Dynasylan® 4140) consisted essentially of the reactant reservoir vessels, HPLC pumps, control, measurement, and metering units, a T mixer, four replaceable stainless steel preliminary reactors, connected in series and packed with packing elements (the reactors each being as follows: diameter 10 mm, length 50 mm, stainless steel beads with on average 1.5 mm diameter as packing elements), an integrated stainless steel block reactor—cf. also FIG. 5 on this point—, temperature regulation, a pressure maintenance valve, a stripping column operated with N₂, and connecting lines in the system for reactant supply, between the abovementioned system components and also product discharge, recycling takeoff, and offgas removal. Furthermore, thermal conditioning was provided via a heating and cooling system for the preliminary reactors and for the block reactor.

First of all, at room temperature, the polyetherolefin (ZALP 500, Goldschmidt) and an acetonic, HOAc-containing solution of hexachloroplatinic acid in a molar olefin:Pt ratio of 48 000:1 and a molar olefin:acetic acid ratio of 1:0.01 were metered and mixed and this mixture was mixed in the T mixer with trimethoxysilane (TMOS, Degussa AG) in a molar olefin:TMOS ratio of 1:0.85, and supplied to the reactor system. The pressure was 25±10 bar. When the system is being run up, the aim ought to be for a very highly H₂O-free condition of the system. Furthermore, before the temperature in the reactor was raised, the system was flushed with reactant mixture for 2 hours. At a throughput totalling 10 kg/h, the temperature in the reactors was raised, set at 110° C. and operated continuously over 27 days. According to reactor, samples for GC-WLD measurements were taken at intervals of time. The conversion, based on the olefin, was 97% on average and the selectivity, based on the target product, was 75%. The crude product obtained was passed continuously into the stripping column and stripped continuously at a jacket temperature of 150° C., p=20 mbar, with N₂ (volume flow=100 l/h, T=150° C.). The top product was condensed and consisted of around 4% by weight of acetone, 5% by weight of acetic acid, 78% by weight of TMOS, 11% by weight of tetramethoxysilane and 2% by weight of methanol. From the bottom a figure of around 9.8 kg/h of hydrosilylation product (Dynasylan® 4140) were taken off continuously.

### Example 2

### Preparation of 3-(methylpolyethylene glycol)propyltrimethoxysilane

For the continuous preparation of 3-(methylpolyethylene glycol)propyltrimethoxysilane (Dynasylan® 4140), a system according to example 1 was used.

First of all, at room temperature, the polyetherolefin (ZALP 500, Goldschmidt) and a xylene-containing solution of the Pt(0) complex catalyst (CPC072, Degussa) in a molar olefin:Pt ratio of 48 000:1 and a molar olefin:propionic acid ratio of 1:0.01 were metered and mixed and this mixture was mixed in the T mixer with trimethoxysilane (TMOS, Degussa AG) in a molar olefin:TMOS ratio of 1:0.85, and supplied to the reactor system. The pressure was 25±10 bar. When the system is being run up, the aim ought to be for a very highly H₂O-free condition of the system. Furthermore, before the temperature in the reactor was raised, the system was flushed with reactant mixture for 2 hours. At a throughput totaling 10 kg/h, the temperature in the reactors was raised, set at 130° C. and operated continuously over 10 days. According to reactor, samples for GC-WLD measurements were taken at intervals of time. The conversion, based on the olefin, was 97% on average and the selectivity, based on the target product, was 80%. The crude product obtained was passed continuously into the stripping column and stripped continuously at a jacket temperature of 150° C., p=200 mbar, with N₂ (volume flow=100 l/h, T=150° C.). The top product was condensed and consisted of 9% by weight of propionic acid, 80% by weight of TMOS, 10% by weight of tetramethoxysilane and 1% by weight of xylene. From the bottom a figure of around 9.8 kg/h of hydrosilylation product (Dynasylan® 4140) were taken off continuously.

1. A system for the continuous industrial implementation of a reaction, an α,β-unsaturated aliphatic polyether compound A being reacted with an HSi compound B in the presence of a catalyst C and optionally of further auxiliaries, and the system being based at least on the
reactant combiner (3) for components A (1) and B (2), on
at least one multielement reactor (5), which in turn comprises at least two reactor units in the form of at least one replaceable preliminary reactor (5.1) and at least one further reactor unit (5.3), downstream of the preliminary reactor system, and on
a product workup unit (8).

2. A system according to claim 1,
characterized by
a reactor unit (5.3) which in turn includes 1 to 100 000 reactor units.

3. A The system according to claim 1,
characterized by
reactor units, a preliminary reactor (5.1) having a free reaction volume of 5 ml to 10 l, and a reactor unit (5.3) having in total a free reaction volume of 1 ml to 100 l.

4. A system according to claim 1,
characterized by
at least one multielement reactor (5) which is based (i) on at least two preliminary reactors (5.1) connected in parallel and on at least one stainless-steel capillary downstream of the preliminary reactors, or (ii) on at least two preliminary reactors (5.1) connected in parallel and on at least one quartz-glass capillary downstream of the preliminary reactors, or (iii) on at least two preliminary reactors (5.1) connected in parallel and on at least one integrated block reactor (5.3.1), or (iv) on at least two preliminary reactors (5.1) connected in parallel and on at least one micro-tube bundle heat exchanger reactor (5.9).

5. A system according to claim 1,
characterized by
at least two preliminary reactors (5.1) furnished with packing elements.

6. A system according to claim 1,
characterized by
a multielement reactor (5) which comprises four to eight preliminary reactors (5.1) connected in parallel and packed with packing elements, and an integrated block reactor (5.3.1) downstream of the preliminary reactors which in turn comprises 10 to 4000 reactor units (5.5).

7. A multielement reactor (5) for the reaction of hydrolyzable silanes, which in turn comprises at least two reactor units in the form of replaceable preliminary reactors (5.1) and at least one further reactor unit (5.3) downstream of the preliminary reactors.

8. A system according to claim 1,
characterized by
preliminary reactors (5.1) which are packed with structured packing elements (5.1.3).

9. A process for the continuous industrial production of a polyether-alkylalkoxysilane of the general formula (I)
Y—Si(R′)ₘ(OR)₃₋ₘ (I),
in which Y is a polyetheralkyl group of the form H₃C[O—(CH₂)₂]ₙO—(CH₂)₃— with n=1 to 20 or H[O—(CH₂)₂]ₙO—(CH₂)₃— with n=1 to 20, R′ and R independently are a C₁ to C₄ alkyl group, and m is 0 or 1,
the reaction of the reactant components A and B in the presence of a catalyst C and also optionally of further components being carried out in a multielement reactor (5) which in turn is based on at least two reactor units in the form of at least one replaceable preliminary reactor (5.1) and at least one further reactor unit (5.3) downstream of the preliminary reactor system.

10. A process according to claim 9,
characterized in that
the reaction is carried out in at least one multielement reactor (5), the reactor units being made of stainless steel and at least two of the preliminary reactors (5.1) being furnished with packing elements (5.1.3).

11. A process according to claim 9,
characterized in that
a component A from the series H₃C[O—(CH₂)₂]ₙO—CH₂CH═CH₂ where n=1 to 20 or H[O—(CH₂)₂]ₙO—CH₂CH═CH₂ where n=1 to 20 is reacted with a silane (component B) of the general formula (II)
HSi(R′)ₘOR₃₋ₘ (II),
in which R′ and R independently are a C₁ to C₄ alkyl group and m is 0 or 1.

12. A process according to claim 9,
characterized in that
component B (hydrogensilane) and component A (polyetherolefin) are used in a molar ratio of 0.7 to 0.9:1.

13. A process according to claim 9,
characterized in that
a homogeneous catalyst C is used, relative to the noble metal, in a molar ratio to component A of 1 to 2:60 000.

14. A process according to claim 9,
characterized in that
the reaction is carried out in the presence of a catalyst C based on PtCl₄ or H₂PtCl₆.

15. A process according to claim 9,
characterized in that
the multielement reactor (5) is preconditioned with a catalyst-containing reactant mixture.

16. A process according to claim 9,
characterized in that
the reaction in the multielement reactor (5) is operated at a temperature of 90 to 140° C. and at a pressure of 15 to 35 bar abs.

17. A process according to claim 9,
characterized in that
the reaction is carried out with an average residence time of 1 minute to 10 minutes.

18. A process according to claim 9,
characterized in that
the reaction is carried out with a ratio of reactor surface area to reactor volume (A/V) of 20 to 50 000 m¹/m³.

19. A process according to claim 9,
characterized in that
the reactant components A, B, and C are continuously metered and mixed, then a defined volume flow of the reactant mixture is supplied to the multielement reactor (5) and reacted, and subsequently the resulting product mixture is worked up.

20. A process according to claim 9,
characterized in that
a reactant mixture based on components A, B, and C is used which comprises as a further component an organic or inorganic acid.

21. A process according to claim 9,
characterized in that
acetic acid is used as a further component and the molar ratio of acetic acid to component A is set at 0.01 to 5:10 000.

22. A process according to claim 9,
characterized in that,
after a defined operating time of the system, at least one preliminary reactor (5.1), which optionally is packed with packing elements (5.1.3), is replaced by a fresh preliminary reactor, optionally furnished with packing elements, while at least one further preliminary reactor (5.1) is continued in operation for the implementation of the continuous operation.

23. A process according to claim 9,
characterized in that
the flow rate in the preliminary reactors (5.1) is lower than that in the downstream reactor units.

24. The multielement reactor according to claim 7,
comprising
preliminary reactors (5.1) which are packed with structured packing elements (5.1.3).
